(19) United States
(12) Patent Application Publication
(10) Pub. No.: US 2026/0079697 A1
(43) Pub. Date: Mar. 19, 2026

(54) AUTOMATED CODE REPAIR USING GENERATIVE AI

(71) Applicant: SAP SE, Walldorf (DE)

(72) Inventors: Krishnan Harihara SUBRAMANIAN, Bangalore (IN); Dinesh BHANDARKAR, Bangalore (IN); Ajay P SAKTHIKUMAR, Munnar (IN)

(21) Appl. No.: 18/889,606

(22) Filed: Sep. 19, 2024

(51) Int. Cl. G06F 8/71; G06F 8/30; G06F 8/41; G06F 11/36

(52) U.S. Cl. CPC G06F 8/71; G06F 8/30; G06F 8/41; G06F 11/3636

(57) ABSTRACT

Systems and methods include detection of a new version of software code in a version control system and, in response to the detection of the new version of software code, automatically build an application from the new version of software code, execute the application, detect an error in the execution of the application, in response to detection of the error, instruct a text generation model to generate corrected software code based on the error and the new version of software code, build a second version of the application from the corrected software code, execute the second version of the application, and, based on the execution of the second version of the application, save the corrected software code to the version control system.

### BACKGROUND

Software applications are ubiquitous in the operations of modern organizations. An organization may use many different software applications, which include off-the-shelf applications, customized applications, and/or applications developed specifically for the organization. These software applications may be executed by user devices, on-premise servers, and/or cloud-based servers.

Modern software applications are complex. For example, an enterprise application may include millions of lines of code written by hundreds of different developers. Such complexity is needed to provide the functionality, speed, process integration, security, redundancy, scalability, and other characteristics required by organizations which execute the applications.

Development and maintenance of these applications is quite difficult in view of their complexities. Nevertheless, an application must be regularly updated to fix bugs, add features and improve performance. Updates may also be required to ensure compatibility with public or proprietary libraries on which the application relies, with other applications which are called by the application, and with other applications which call the application. Moreover, current continuous integration/continuous deployment paradigms exert pressure to increase the frequency of updates.

Systems to efficiently facilitate application development and maintenance are desired.

### BRIEF DESCRIPTION OF THE DRAWINGS

FIG. 1 is a block diagram of an architecture to repair software code according to some embodiments.

FIG. 2 comprises a flow diagram of a process to repair software code according to some embodiments.

FIG. 3 illustrates generation of prompts during an iterative process to repair code according to some embodiments.

FIG. 4 is an example of detected code according to some embodiments.

FIG. 5 is an example of corrected code according to some embodiments.

FIG. 6 is a user interface presenting a code correction report according to some embodiments.

FIG. 7 is a block diagram of a hardware environment providing code development and repair according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Some embodiments provide a framework for automating repair of software code in a development environment. Briefly, a ‘self-healing” service detects a new version of code within a version control system or other code repository. In response, the service builds an application using the code and executes the application within a secure sandbox, If the build or execution results in errors, a text generation model (e.g., a Large Language Model (LLM)) is instructed to generate corrected code based on the errors. An application is built from the corrected code and the application is executed. If this build or execution also results in errors, the cycle repeats.

In some embodiments, only a certain threshold number of cycles are executed until the process aborts. If an application is built and executed without errors, the code from which the application was built is saved to the code repository. In some embodiments, this “corrected” code is merged with a current branch of the code within the code repository.

Embodiments may reduce the amount of time needed to develop and test code in response to changing conditions. Code monitoring resources and system downtime may also be reduced due to improved code quality.

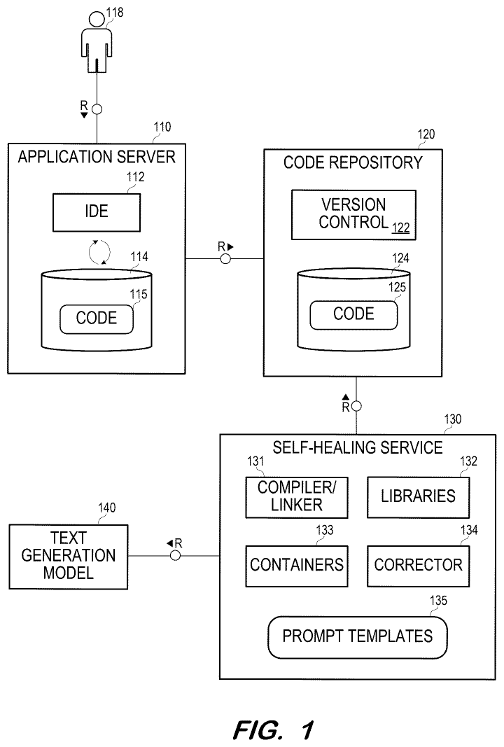

FIG. 1 is a block diagram of an architecture to repair software code according to some embodiments. Each of the illustrated components may be implemented using any suitable combination of on-premise, cloud-based, distributed (e.g., including distributed storage and/or compute nodes) computing hardware and/or software that is or becomes known. Each computing system described herein may comprise one or more physical and/or virtualized servers.

Two or more components of FIG. 1 may be co-located. In some embodiments, two or more components are implemented by a single computing device. One or more components may be implemented as a cloud service (e.g., Software-as-a-Service, Platform-as-a-Service). A cloud-based implementation of any components of FIG. 1 may apportion computing resources elastically according to demand, need, price, and/or any other metric.

Application server 110 may comprise one or more servers, virtual machines, clusters of a container orchestration system, etc. Application server 110 may provide an operating system, services, I/O, storage, libraries, frameworks, etc. to applications executing therein, such as integrated development environment (IDE) 112. Application server 110 may execute other unshown applications in addition to IDE 112.

IDE 112 may comprise program code executable by a processing unit to provide code development functions to users such as user 118. For example, user 118 may access IDE 112 via a Web browser executing a front-end user interface (UI) application associated with IDE 112. IDE 112 may facilitate the development of executable code conforming to a given programming language (e.g., Python, UI5, Typescript, JavaScript, C and C++, Ruby on Rails, GoLang) by providing editing, compiling and debugging functions as is known in the art. Embodiments are not limited to any programming language or type of IDE.

Code 115 may include code developed using IDE 112 and/or other code. Code 115 is stored in data store 114, which may comprise any suitable storage system including but not limited to a database system. Data store 114 may be located partially or fully remote from application server 110, and may be distributed as is known in the art.

Assuming that user 118 has code submission access to code repository 120, user 118 may instruct IDE 112 to store code in code repository 120 and request code therefrom. Code repository 120 executes version control component 122, which may comprise any logic to support saving code to code 125 of data store 124, versioning of the saved code, and retrieval of code 125 from data store 124. Code repository 120 may comprise a source code versioning system such as but not limited to GitHub. Code repository 120 may be implemented using distributed servers and storage that is known in the art.

According to conventional code development practices, a code repository may be used to allow disparate developers to work on the same or related code while keeping track of different saved versions of the code. Code may be saved to a same or new version number, while “checking-in” code refers to saving code to a main branch of a project. Once approved (if approval is acquired), the checked-in code is used during the building of an application from the code files of the project.

Self-healing service 130 may monitor code repository 120 to identify new versions of code saved to code 125. In some embodiments, version control system 122 notifies self-healing service 130 of new versions of code saved to code 125.

Self-healing service 130 includes compiler/linker 131 to build an application based on a detected new version of code. Compiler/linker 131 comprises program code to perform known compiling and linking functions for code written in the respective programming language of the detected new version of code. Building an application from the detected new version of code may require retrieval of other code files of the same project from code 125, as well as retrieval of any required code libraries. In this regard, self-healing service may also store code libraries 132 for use in building applications.

Service 130 also includes one or more containers 133, such as but not limited to a Docker container, for executing applications. A container 133 may comprise an executable file including dependencies needed to execute an application on the host operating system of service 130, such as libraries, binaries, configuration files, and frameworks. The built application is executed within containers 133.

Corrector 134 is executed to repair, or correct, the new version of code, if necessary. Errors may occur during the building of an application by compiler/linker 131 and/or execution of the application by container 133. Corrector 134 is executed to generate corrected code based on these errors using prompt templates 135 in conjunction with text generation model 140.

More specifically, corrector 134 may select a system prompt template and a user prompt template from prompt templates 135. The selected templates are populated with code to be corrected and errors which were raised by compiler/linker 131 and/or container 133. The populated templates are sent to text generation model 140 to instruct model 140 to generate corrected code.

Text generation model 140 may comprise a neural network trained to generate text based on input text. Text generation model 140 may be implemented by, for example, executable program code, a set of hyperparameters defining a model structure and a set of corresponding weights, or any other representation of an input-to-output mapping which was learned as a result of the training.

According to some embodiments, model 140 is an LLM conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 140 include GPT-4, LaMDA, and Claude. Model 140 may be publicly available or deployed within a landscape which is trusted by a provider of application server 110. Similarly, text generation model 140 may be trained based on public and/or private data.

Text generation model 140 generates code in response to the prompts received from corrector 134 and returns the generated code to corrector 134. According to some embodiments, the above process repeats with respect to the generated code. That is, compiler/linker 131 rebuilds the application based on the generated code, the rebuilt application is executed by a container 133 and, if any errors were raised, corrector 134 uses prompt templates 135 to instruct model 140 to generate corrected code.

If no errors are raised, corrector 134 may return the corrected code to code repository 120. Version control system 122 may automatically check-in the returned code to merge the corrected code with a main branch of the project to which the corrected code belongs. Accordingly, in some embodiments, code saved by IDE 112 may be automatically corrected and checked-in to code repository 120 without requiring further action of the code developer.

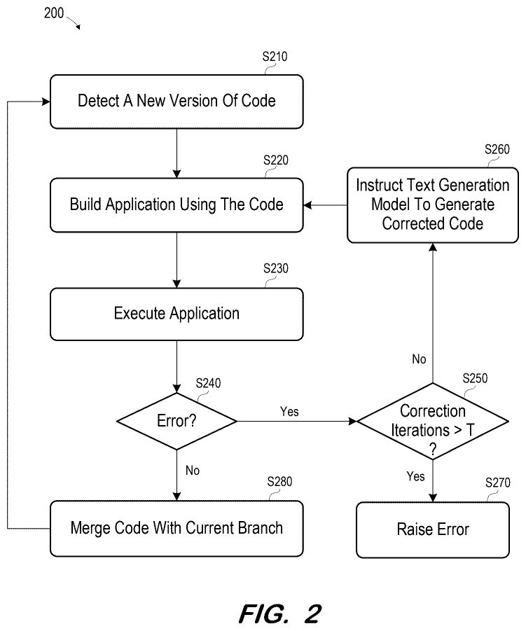

FIG. 2 comprises a flow diagram of process 200 to repair code according to some embodiments. Process 200 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

Initially, a new version of software code is detected at S210. The software code may comprise any logical unit or units of code, including a function, a module, an application, etc. S210 may comprise monitoring a version control system which stores versions of the code. More specifically, S210 may comprise determining whether a new version of the code has been saved by to the version control system. In some examples, a developer may check-out the code, make changes thereto using an IDE, and request the version control system to save the changed version of the code. In response, the version control system assigns a new version number to the code and stores the new version of the code. This storage of the code may result in a detection of the new version of the code at S210.

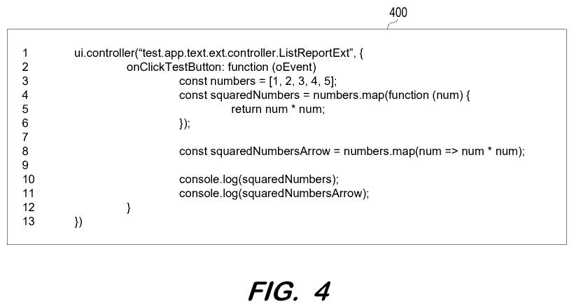

FIG. 4 is an example of code 400 detected at S210 according to some embodiments. Code 400 includes a syntax error, i.e., the callback for onClickTestButton event is not enclosed with “{ }”. Embodiments are not limited to the language, function, length or format of code 400.

Next, at S220, an application is built based on the detected new version of code. As is known in the art, building the application includes compiling the code and linking the compiled code with other compiled code. The other compiled code may include other code of the same project and any required code libraries.

The application built at S220 is executed at S230. Execution at S230 may comprise unit test cases, end-to-end test cases, Qmate, TOSCA or OPA5 scripts, etc. The application may be executed within a container and any errors resulting from the execution are detected. In some embodiments, errors may also be detected during the building of the application at S220. If the errors detected at S220 prevent building of the application at S230, flow may proceed directly to S240 from S220.

At S240, it is determined whether any errors occurred during execution of the application at S230 (and/or during building of the application at S220). If so, flow proceeds to S250 to determine whether a number of correction iterations which have been performed with respect to the detected new version of code is greater than a maximum number of iterations (e.g., T=3). The present example is at the first iteration so flow continues to S260.

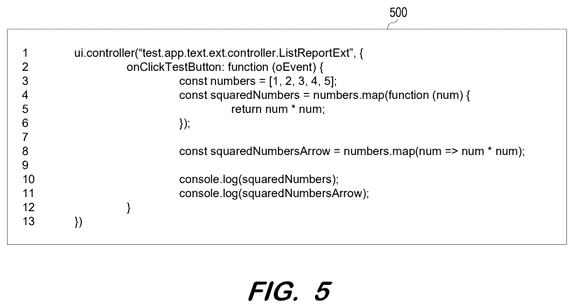

At S260, a text generation model is instructed to generate new code. For example, a system prompt template and a user prompt template may be selected based on the types of errors detected at S240, the type of code, etc. The selected templates are populated with the code detected at S210 and with information regarding the errors which were detected at S250. The populated templates are then sent to a text generation model to generate corrected code. FIG. 5 is an example of code 500 generated at S260 according to some embodiments. Code 500 was generated by a text generation model based on code 400 of FIG. 4 and the above-mentioned syntax error detected at S220 during building of an application based on code 400.

Flow then returns to S220 to build the application based on the corrected code generated at S260. The rebuilt application, which may be considered a new version of the application, is executed at S230. At S240 it is determined whether the execution resulted in any errors. If so, flow proceeds to S250 to compare the number of the current iteration with the maximum number of iterations. Flow therefore cycles from S220 to S260 until no errors are detected at S240 or a maximum number of iterations has been executed.

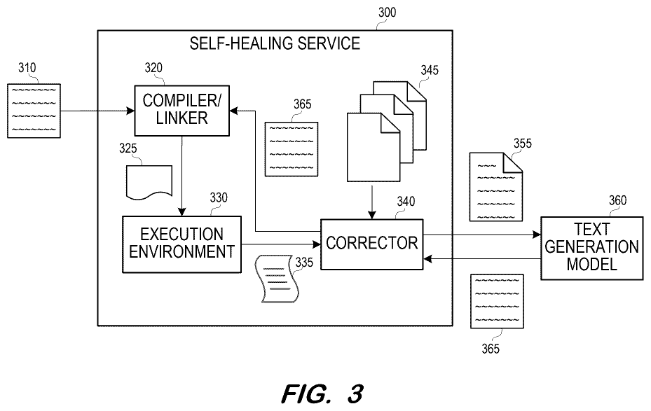

FIG. 3 illustrates the iterative execution loop of process 200 according to some embodiments. Self-healing service 300 detects new code version 310 and compiler/linker 320 builds application 325 based on new code version 310. Execution environment 330, which may comprise a container as described above, executes application 325 and generates errors 335 associated with the execution.

Corrector 340 selects one or more of prompt templates 345. The one or more templates may be selected based on errors 335, a type of code 310, a function of code 310, etc. Corrector 340 populates the selected one or more templates with code 310 and with errors 335 to generate populated template 355. Populated template 355 may comprise a system prompt and a user prompt in some embodiments.

Corrector 340 transmits populated template 355 to text generation model 360 and receives corrected code 365 in return. Corrector 340 provides corrected code 365 to compiler/linker 320 to build a next instance of application 325. Flow continues in this manner until no errors are raised by execution environment 330 or a maximum number of iterations has been executed.

If no errors are detected at S240 during a first iteration of process 200, the new version of code detected at S210 is automatically merged with a current code branch at S280. If no errors are detected at S240 during subsequent iterations, the most recently-generated corrected code is automatically merged with a current code branch. For example, a version control system from which the new version of code was detected may be instructed at S280 to check-in the code to merge the code with a main branch of the project to which the code belongs.

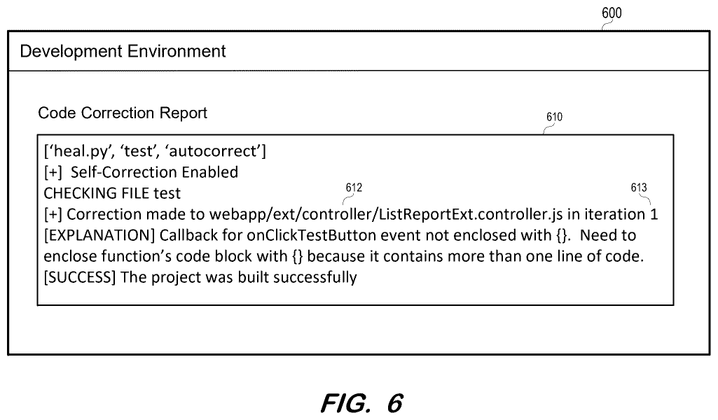

S280 may also include generation of a report describing the correction. FIG. 6 illustrates user interface 600 of an IDE according to some embodiments. In one example, user 118 executes a Web browser to access IDE 112 via HyperText Transfer Protocol and receives user interface 600 in return.

User interface 600 includes area 610 for presenting a code correction report. In the illustrated example, the report indicates name 612 of the corrected code and a number 613 of iterations required to correct the code. Moreover, report 610 describes a detected error and the change made to the code to correct the error. The text generation mode may be instructed to generate, along with the corrected code, the descriptions of the detected error and the change made to the code.

During execution of process 200, it may be determined at S250 that a number of correction iterations has exceeded the threshold number. If so, flow proceeds to S270 to raise an error. The error may indicate that the new version of code includes errors which could not be corrected. The error may be passed to a version control system and onto a developer responsible for the code.

In one non-exhaustive example, the following system prompt template and user prompt template may be used at S260 in some embodiments. The user prompt template requires population with code and error messages, and the system prompt template may be sent to the text generation model as-is.

```
[BEGIN SYSTEM PROMPT]
[
  {
    ″role″: ″assistant″,
    ″content″: ″I am a Self-Healing code assistant.″
  },
  {
    ″role″: ″assistant″,
    ″content″: ″I assist with identifying, validating and rectifying source code written in
various languages.″
  },
  {
    ″role″: ″assistant″,
    ″content″: ″I will be able to correct code, given the source code and error messages.″
  },
  {
    ″role″: ″assistant″,
    ″content″: ″I will always return a json string with relevant data. The json string will be
surrounded by \″ for keys and values. The json will be of form {\″TYPE\″:
\″CORRECTION\″ / \″PASSED\″ / \″FAILED\″ / \″COVERSATION\″,\″DATA\″:
\″corrected source code\″ / \″reason for success or failure\″}″
  },
  {
    ″role″: ″assistant″,
    ″content″: ″The keys and values returned json string will always be surrounded by \″″
  },
  {
    ″role″: ″assistant″,
    ″content″: ″When TYPE is CORRECTION, DATA will contain only the corrected
source code. It will contain the whole corrected source code and no additional content.″
  },
  {
    ″role″: ″assistant″,
    ″content″: ″Example response for “How are you?” could be {\″TYPE\″:
\″CONVERSATION\″,\″DATA\″: \″I am doing well\″}″
  },
  {
    ″role″: ″assistant″,
    ″content″: ″I will return only the json data″
  },
  {
    ″role″: ″user″,
    ″content″: ″What does async mean?″
  },
  {
    ″role″: ″assistant″,
    ″content″: ″{\″TYPE\″: \″CONVERSATION\″,\″DATA\″: \″In terms of tech, async is
used to denote asynchronous functions\″}″
  }
]
[END SYSTEM PROMPT]
[BEGIN USER PROMPT]
<source code>
      populate with source code
< error messages>
      populate with error messages
[END USER PROMPT]
```

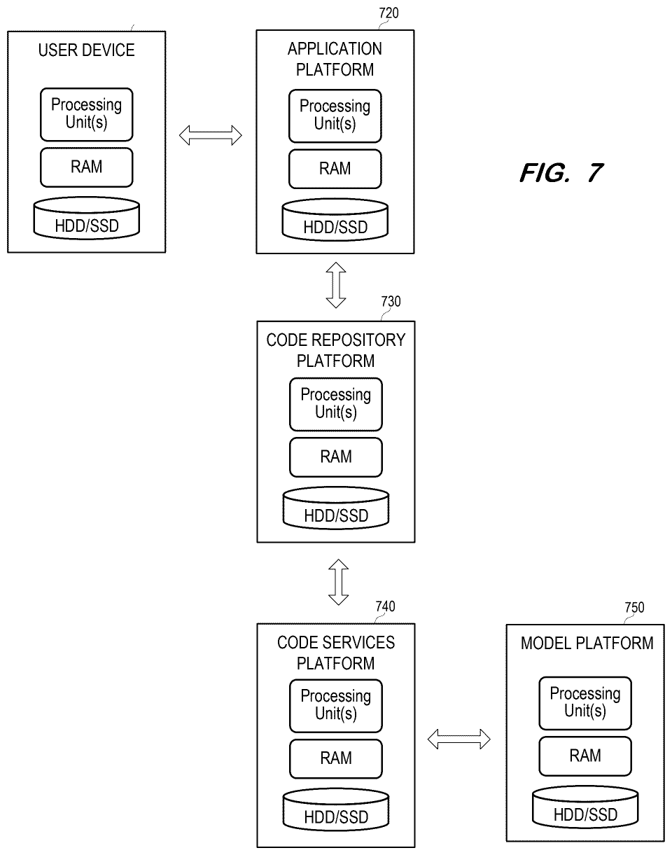

FIG. 7 is a block diagram of a cloud-based system according to some embodiments. Application platform 720, code repository platform 730, code services platform 740 and model platform 750 may each comprise cloud-based resources, such as virtual machines, allocated by a cloud provider providing self-service and immediate provisioning, autoscaling, security, compliance and identity management features.

User device 710 may present a user interface of an integrated development environment application executing on application platform 720. The user interface may provide editing and other code development functions. Application platform 720 may forward a request to save edited code to code repository platform 730. A coding service executing on code services platform 740 may operate as described herein in conjunction with a text generation model executing on model platform 750 to correct the saved code and to instruct code repository platform 730 to merge the corrected code with a main branch of a project.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing program code; and
one or more processing units to execute the program code to cause the system to:
detect a new version of software code in a version control system; and
in response to the detection of the new version of software code, automatically:
build an application from the new version of software code;
execute the application;
detect an error in the build of the application or the execution of the application;
in response to detection of the error, instruct a text generation model to generate corrected software code based on the error and the new version of software code;
build a second version of the application from the corrected software code;
execute the second version of the application; and
based on the execution of the second version of the application, save the corrected software code to the version control system.

2. The system according to claim 1, wherein instructing of the text generation model to generate corrected software code comprises:
selection of a prompt template based on the error from a plurality of prompt templates; and
population of the selected prompt template with the new version of software code and the error.

3. The system according to claim 2, wherein each of the plurality of prompt templates is associated with a respective error.

4. The system according to claim 2, wherein saving of the corrected software code to the version control system comprises merging the corrected software code with a main branch of software code.

5. The system according to claim 1, wherein saving of the corrected software code to the version control system comprises merging the corrected software code with a main branch of software code.

6. The system according to claim 5, the one or more processing units to execute the program code to cause the system to:
detect a new version of second software code in the version control system; and
in response to the detection of the new version of second software code, automatically:
build a third version of the application from the new version of second software code;
execute the third version of the application;
detect a second error in the build of the third version of the application or the execution of the third version of the application;
in response to detection of the second error, instruct the text generation model to generate second corrected software code based on the second error and the new version of second software code;
build a fourth version of the application from the second corrected software code;
execute the fourth version of the application;
detect a third error in the build of the fourth version of the application or the execution of the fourth version of the application;
in response to detection of the third error, instruct the text generation model to generate third corrected software code based on the third error and the second corrected software code;
build a fifth version of the application from the third corrected software code;
execute the fifth version of the application;
detect a fourth error in the build of the fifth version of the application or the execution of the fifth version of the application; and
in response to detection of the fourth error, return a correction error to the version control system.

7. The system according to claim 1, the one or more processing units to execute the program code to cause the system to:
detect a new version of second software code in the version control system; and
in response to the detection of the new version of second software code, automatically:
build a third version of the application from the new version of second software code;
execute the third version of the application;
detect a second error in the build of the third version of the application or the execution of the third version of the application;
in response to detection of the second error, instruct the text generation model to generate second corrected software code based on the second error and the new version of second software code;
build a fourth version of the application from the second corrected software code;
execute the fourth version of the application;
detect a third error in the build of the fourth version of the application or the execution of the fourth version of the application;
in response to detection of the third error, instruct the text generation model to generate third corrected software code based on the third error and the second corrected software code;
build a fifth version of the application from the third corrected software code;
execute the fifth version of the application;
detect a fourth error in the build of the fifth version of the application or the execution of the fifth version of the application; and
in response to detection of the fourth error, return a correction error to the version control system.

8. A method comprising:
detecting a check-in of a new version of software code in a code repository; and
in response to detecting the check-in, automatically:
building an application from the new version of software code;
executing the application;
detecting an error in the execution of the application;
in response to detecting the error, instructing a text generation model to generate corrected software code based on the error and the new version of software code;
building a second version of the application from the corrected software code;
executing the second version of the application; and
based on the execution of the second version of the application, saving the corrected software code to the code repository.

9. The method according to claim 8, wherein instructing the text generation model to generate corrected software code comprises:
selecting a prompt template based on the error from a plurality of prompt templates; and
populating the selected prompt template with the new version of software code and the error.

10. The method according to claim 9, wherein each of the plurality of prompt templates is associated with a respective error.

11. The method according to claim 9, wherein saving the corrected software code comprises merging the corrected software code with a main branch of software code.

12. The method according to claim 8, wherein saving the corrected software code comprises merging the corrected software code with a main branch of software code.

13. The method according to claim 12, further comprising:
detecting a new version of second software code in the version control system; and
in response to detecting the new version of second software code, automatically:
building a third version of the application from the new version of second software code;
executing the third version of the application;
detecting a second error in the execution of the third version of the application;
in response to detecting the second error, instructing the text generation model to generate second corrected software code based on the second error and the new version of second software code;
building a fourth version of the application from the second corrected software code;
executing the fourth version of the application;
detecting a third error in the execution of the fourth version of the application;
in response to detecting the third error, instructing the text generation model to generate third corrected software code based on the third error and the second corrected software code;
building a fifth version of the application from the third corrected software code;
executing the fifth version of the application;
detecting a fourth error in the execution of the fifth version of the application; and
in response to detecting the fourth error, returning a correction error to the code repository.

14. The method according to claim 8, further comprising:
detecting a new version of second software code in the version control system; and
in response to detecting the new version of second software code, automatically:
building a third version of the application from the new version of second software code;
executing the third version of the application;
detecting a second error in the execution of the third version of the application;
in response to detecting the second error, instructing the text generation model to generate second corrected software code based on the second error and the new version of second software code;
building a fourth version of the application from the second corrected software code;
executing the fourth version of the application;
detecting a third error in the execution of the fourth version of the application;
in response to detecting the third error, instructing the text generation model to generate third corrected software code based on the third error and the second corrected software code;
building a fifth version of the application from the third corrected software code;
executing the fifth version of the application;
detecting a fourth error in the execution of the fifth version of the application; and
in response to detecting the fourth error, returning a correction error to the code repository.

15. One or more non-transitory media storing program code executable by one or more processing units of a computing system to cause the computing system to:
detect a check-in of a version of software code in a version control system; and
in response to the detection of the check-in, automatically:
build an application from the version of software code;
execute the application;
detect an error in the execution of the application;
in response to detection of the error, instruct a text generation model to generate corrected software code based on the error and the version of software code;
build a second version of the application from the corrected software code;
execute the second version of the application; and
based on the execution of the second version of the application, save the corrected software code to the version control system.

16. The one or more non-transitory media of claim 15, wherein instructing of the text generation model to generate corrected software code comprises:
selection of a prompt template based on the error from a plurality of prompt templates; and
population of the selected prompt template with the version of software code and the error.

17. The one or more non-transitory media of claim 16, wherein each of the plurality of prompt templates is associated with a respective error.

18. The one or more non-transitory media of claim 16, wherein saving of the corrected software code to the version control system comprises merging the corrected software code with a main branch of software code.

19. The one or more non-transitory media of claim 15, wherein saving of the corrected software code to the version control system comprises merging the corrected software code with a main branch of software code.

20. The one or more non-transitory media of claim 15, the program code executable by one or more processing units of a computing system to cause the computing system to:
detect a second check-in of a version of second software code in the version control system; and
in response to the detection of the second check-in, automatically:
build a third version of the application from the version of second software code;
execute the third version of the application;
detect a second error in the execution of the third version of the application;
in response to detection of the second error, instruct the text generation model to generate second corrected software code based on the second error and the version of second software code;
build a fourth version of the application from the second corrected software code;
execute the fourth version of the application;
detect a third error in the execution of the fourth version of the application;
in response to detection of the third error, instruct the text generation model to generate third corrected software code based on the third error and the second corrected software code;
build a fifth version of the application from the third corrected software code;
execute the fifth version of the application;
detect a fourth error in the execution of the fifth version of the application; and
in response to detection of the fourth error, return a correction error to the version control system.
